(19) United States
(12) Patent Application Publication
(10) Pub. No.: US 2022/0092695 A1
(43) Pub. Date: Mar. 24, 2022

(54) TRIGGERING TRANSACTIONS BASED ON PREDEFINED EVENTS

(71) Applicant: Wells Fargo Bank, N.A., San Francisco, CA (US)

(72) Inventors: Fredrik Axsater, San Francisco, CA (US); Sean D. Fullerton, Lexington, MA (US); Dennis H. Heinke, San Francisco, CA (US); Jonathan P. Hobbs, Alameda, CA (US); Leslie Laubach, San Francisco, CA (US); Nathaniel S. Miles, Hingham, MA (US); Daniel Morris, Oxshott (GB); Nelli Oster, San Francisco, CA (US); Don Stroube, San Francisco, CA (US); Duane Whitney, San Francisco, CA (US); Joseph Wong, San Francisco, CA (US)

(21) Appl. No.: 16/584,796

(22) Filed: Sep. 26, 2019

(51) Int. Cl. G06Q 40/06; G06Q 40/02

(52) U.S. Cl. CPC G06Q 40/06; G06Q 40/02

(57) ABSTRACT

Systems, methods, and apparatuses for improved retirement income plans are provided. A method includes determining that a user is a participant in a retirement income Collective Investment Trust (CIT); retrieving an age of the user; determining that the age of the user is less than a first predefined age, and investing a portion of the retirement income CIT in a Target-Date Fund (TDF); transferring a predetermined amount of the TDF into an asset preservation fund when the age of the user is greater than or equal to the first predefined age and less than a second predefined age; and, based on the user's age being greater than or equal to the second predefined age, (i) purchasing a Qualified Longevity Annuity Contract (QLAC) with funds from the asset preservation fund, and (ii) transferring a current balance of the TDF into a draw down fund.

### TECHNICAL FIELD

The present disclosure relates generally to defined contribution retirement solutions. More particularly, the present disclosure relates to improved systems and computing infrastructures for processing of accounts that increase the sophistication and performance of such retirement solutions.

### BACKGROUND

One type of investment within a retirement account or portfolio includes a Target Date Fund (TDF). A TDF is a popular retirement investment portfolio account for consumers who desire low-cost investing with automatic rebalancing of assets over the lifetime of such investment funds. But while TDFs provide useful passive investing vehicles prior to retirement, they are not optimized for participants who have already retired. Thus, one problem unaddressed by TDF-based retirement portfolios is longevity risk (e.g., the risk that a retiree may outlive his or her retirement savings), and participants must self-insure against this risk. Some studies have estimated that eighteen years after retirement, nearly half of the users still have eighty-percent or more of their original balances in their retirement account. This is due to the users being reluctant to spend down their capital base during their early years of retirement because of inefficient planning, and no inherent support in TDF-based investment portfolios for planning for longevity of an unknown duration. Further, management of the TDF after retirement may be technically complicated as users may withdraw funds inconsistently, which leads to inconsistent processing burdens on the system that administers and manages the retirement plan.

### SUMMARY

A first example embodiment relates to a non-transitory computer-readable medium storing instructions that, when executed by one or more processors, cause a computing system to: determine that a user is a participant in a retirement income Collective Investment Trust (CIT); in response to determining that the user is a participant in a retirement income CIT, retrieve status information regarding the user comprising an age of the user; in an instance in which the age of the user is less than a first predefined age, invest a portion of the retirement income CIT in a Target-Date Fund (TDF); in an instance in which the age of the user is greater than or equal to the first predefined age and less than a second predefined age, transfer a predetermined amount of funds from the TDF into an asset preservation fund; and, in an instance in which the age of the user is greater than or equal to the second predefined age: purchase a Qualified Longevity Annuity Contract (QLAC) from a preselected carrier with funds from the asset preservation fund, and transfer a current balance of the TDF into a draw down fund.

A second example embodiment relates to a recordkeeper computing system for managing and administering a retirement income plan. The system includes a processing circuit comprising one or more processors coupled to non-transitory memory. The processing circuit may be structured to: determine that a user is a participant in a retirement income Collective Investment Trust (CIT); in response to the determination, retrieve status information regarding the user comprising an age of the user; responsive to determining that the age of the user is less than a first predefined age, invest a portion of the retirement income CIT in a Target-Date Fund (TDF); responsive to determining that the age of the user is greater than or equal to the first predefined age and less than a second predefined age, transfer a predetermined amount of the TDF into an asset preservation fund; and responsive to determining that the age of the user is greater than or equal to the second predefined age, purchase a Qualified Longevity Annuity Contract (QLAC) from a preselected carrier with funds from the asset preservation fund, and transfer a current balance of the TDF into a draw down fund.

A third example embodiment relates to a non-transitory computer-readable medium storing instructions that, when executed by one or more processors, cause a computing system to: provide a dataset with participant information to multiple carriers for a qualified longevity annuity contract (QLAC) pricing quote; upon receiving a response from the multiple carriers, preselect one carrier as the QLAC provider for a retirement income Collective Investment Trust (CIT) based on price and at least one other factor; and send information about the preselected carrier to a recordkeeper computer system.

A fourth example embodiment relates to an asset manager computing system for providing a component for a retirement income plan, The system includes a processing circuit comprising one or more processors coupled to non-transitory memory. The processing circuit may be structured to: provide a dataset with participant information to multiple carriers for qualified longevity annuity contract (QLAC) pricing quotes; upon receiving a response from the multiple carriers, preselect one carrier as the QLAC provider for a retirement income Collective Investment Trust (CIT) based on price and at least one other factor; and send information about the preselected carrier to a recordkeeper computer system.

These and other features, together with the organization and manner of operation thereof, will become apparent from the following detailed description when taken in conjunction with the accompanying drawings.

### BRIEF DESCRIPTION OF THE FIGURES

FIG. 1 is a block diagram of a system for providing and implementing a retirement income CIT as an investment option in a plan sponsor's retirement plan, according to an example embodiment.

FIG. 2 is a flowchart of a method for managing an investment in a retirement income CIT as a function of a participant's age, according to an example embodiment.

FIG. 3 is a flowchart of a method for preselecting a carrier out of a plurality of carriers to be used for a subsequent purchase of a QLAC investment, according to an example embodiment.

FIG. 4 is a graphical depiction of changes in asset allocation and asset categories of the current balance in a retirement income CIT as a function of the age of a participant, according to an example embodiment.

FIG. 5 is a detailed graphical depiction of the asset allocation of a participant as the participant progresses from the accumulation phase, to retirement, to drawdown in retirement, and to disbursal of the annuity payments from the QLAC later on in retirement, according to an example embodiment.

FIG. 6 is a graphical depiction of a glide path of a participant in the retirement income CIT described in FIGS. 1-5, according to an example embodiment.

FIG. 7 is a detailed graphical depiction of the asset allocation of a participant post-retirement and before the annuity payments of the QLAC via the retirement income CIT of FIG. 4, according to an example embodiment.

FIG. 8 is a graphical depiction of an asset allocation for a participant in a 2020 TDF with a QLAC, according to an example embodiment.

### DETAILED DESCRIPTION

In the following detailed description, reference is made to the accompanying drawings, which form a part hereof In the drawings, similar symbols typically identify similar components, unless dictated otherwise. The illustrative embodiments described in the detailed description, drawings, and claims are not meant to be limiting. It will be readily understood that the aspects of the present disclosure, as generally described herein, and illustrated in the figures, can be arranged, substituted, combined, and designed in a wide variety of different configurations, all of which are explicitly contemplated and made part of this disclosure. The terms “participant” and “user” are used interchangeably throughout the following disclosure.

Referring generally to the Figures, the system, methods, and apparatuses described herein ease the administrative and technical burden of administering and managing large-scale accounts and, particularly, retirement accounts. In particular, the systems, methods, and apparatuses provide a retirement income Collective Investment Trust (CIT) as an investment option for participants in a retirement plan administered by a record keeper on behalf of a plan sponsor.

The retirement income CIT or collective investment fund (CIF) is an investment fund that may be provided as part of a retirement plan for a user. The retirement income CIT is a pooled investment vehicle that is managed collectively. As described herein, the retirement income CIT includes a TDF, a QLAC prefunding strategy, and a drawdown fund. In other embodiments, more, less, or different funds/investment options may be included in the retirement income CIT. The presence of the TDF means that the retirement income CIT may be referred to as a TDF-based portfolio. The TDF may be set up as a retirement plan's qualified default investment alternative (QDIA). The retirement income CIT is one of several investment options that a plan sponsor may offer to participants. In one embodiment, the plan sponsor may set up the retirement income CIT as the default investment option for new participants enrolling in the plan sponsor's retirement plan. Participants may be able to opt-in or opt-out of investing in the retirement income CIT at any time. Further, there may be a minimum purchase amount necessary to invest in the retirement income CIT.

The retirement income CIT is structured to automatically perform a transaction at a plurality of predefined events (which may be based on a participant's age), thereby alleviating the need for the plan administrator to continually follow-up with plan participants, track their responses (which takes time and computing resources), and potentially delay or even completely forego certain transaction possibilities (e.g., investments at certain times). As described herein, one predefined event may be retirement, and one transaction may be the automatic purchase of an annuity product, namely, a QLAC. By implementing a plurality of predefined events as part of the retirement income CIT, the number of variables used in processing retirement plans may be decreased, which decreases the strain on computing systems that administer and manage the retirement plans.

A QLAC is a deferred fixed income annuity funded with qualified plan assets (retirement account principal assets). The QLAC is exempted from the Internal Revenue Service (IRS) required minimum distribution until age 85. The QLAC is a governed instrument: currently, the QLAC is limited by law to the lesser of twenty-five (25) percent of the account balance or one-hundred and thirty thousand dollars. The QLAC may be useful in providing longevity protection, increasing income certainty at certain times, and is beneficially purchased with tax-deferred assets (a portion of the retirement income CIT assets). In some embodiments, the QLAC may be a dual-life QLAC, which may include a pre-commencement return of a premium guarantee, a return of a premium guarantee, along with optional features for an early distributions start option. A dual-life QLAC provides fixed or nearly fixed payments not only to the participant but also to a spouse for as long as at least one of them lives. A pre-commencement return of a premium guarantee means that the dollar amount paid to purchase the annuity will be returned to the participant's beneficiary should the participant pass away before the fixed payments start, whereas a return of the premium guarantee means that should a participant pass away after the income payments begin but before he or she has received the full amount paid to purchase the QLAC, the difference is paid to the participant's beneficiary. Further, QLAC annuity products are tax-advantaged, and do not have the requirement of a required minimum distribution (RMD) during the period when the annuity has not reached maturity, subject to IRS regulations on the same. Because of the above mentioned advantages, the QLAC is an advantageous option for providing an assured income during the latter years of retirement.

The shift from defined benefit (DB) to defined contribution (DC) plans has left participants bearing two key risks: i) investment risk, which is the possibility of not achieving investment objectives during asset accumulation and decumulation years; and ii) longevity risk, which is the risk of outliving retirement savings and occurs during the asset decumulation years. DB plans assume longevity risk and pool individual participant risks across the plan so that longer lifespans may be offset by shorter lifespans thereby providing for less uncertainty. In DC plans, each participant assumes their own longevity risk and has to in turn save and invest for the possibility of living longer. As a result, participants may need higher savings for a given level of income in retirement. Or, the participants may need to contend with a lower level of income for a given amount of savings. Self-insuring is a time-consuming, labor-intensive process. This self-insuring often results in underspending during retirement. As a result, the user's retirement may be less fruitful, eventful, and enjoyable. According to the present disclosure, the systems, methods, and apparatuses combine a TDF with a QLAC to help support consumption (e.g., spending) in retirement while hedging longevity risk later in retirement where funds may be needed. The QLAC with the TDF as part of a retirement income CIT is structured to produce/provide a guaranteed or nearly guaranteed periodic income after the participant reaches a predefined age. As described herein, this structure may make the adoption of a retirement income CIT easier for plan participants and easier for recordkeepers to administer on behalf of plan sponsors.

In operation and as a participant progresses in age, traditional TDFs slowly reduce the percentage allocation of their TDF balance to equity investments in favor of asset preservation or income generating funds (i.e., fixed income funds). The system, apparatus, and methods described herein may not reduce the equity investments in the TDFs as much before the user reaches a first predefined age (e.g., 60 years), or even a second predefined age that is greater than the first predefined age (e.g., 65 years, which is the presumptive age of retirement of the participant). That is, the system, apparatus, and methods described herein may allocate a higher percentage of the user's account balance towards equity investments than towards fixed income investments in the TDF-based portfolio as compared to traditional TDFs, which may maximize growth of the funds in the retirement income CIT during the accumulation phase.

Upon the participant reaching the first predefined age, the system, apparatus, and methods described herein may divest, transfer, or otherwise allocate a predetermined amount of funds from the current balance of the retirement income CIT into a separate QLAC prefunding strategy. Such divesting or allocating may continue until the participant reaches a second predefined age (e.g., 65 years), thereby decreasing the current balance of the TDF portion of the retirement income CIT while increasing the current balance of the QLAC prefunding strategy. Upon the participant reaching the second predefined age (e.g., 65 years, which is the presumptive age of retirement of the participant), the current balance of the TDF portfolio (without the QLAC allocation) is transferred into a separate drawdown fund, and the funds in the QLAC prefunding strategy are used to purchase a QLAC for the participant. In some embodiments, the QLAC prefunding strategy may include purchasing long dated treasury bonds fund. In some embodiments, the predetermined amount divested to the QLAC prefunding strategy may be a predetermined percentage of the current balance in the participant's retirement income CIT (e.g., 3%). In one embodiment, the size of predetermined amount is designed to result in approximately fifteen percent of the balance of the retirement account CIT being eventually used towards the purchase of the QLAC. For example, if the first predefined age is 62 and the second predefined age is 65, the predefined amount may be five percent, which would result in fifteen percent of the client's total funds transitioning to the QLAC prefunding strategy at the second age of 65. Regardless of what specific predefined amount is selected to be divested on a yearly basis, this divestiture will begin at the first predefined age for subsequent purchase of the QLAC at the second predefined age.

Beneficially, the funds invested in the drawdown fund may provide a realistic drawdown schedule during the early retirement years by almost exhausting the entire balance of the drawdown fund by the time the participant reaches a third predefined age (e.g., 85 years). The drawdown may be achieved by selling a portion of the assets from the drawdown fund on a periodic basis. Upon the participant reaching the third predefined age, the QLAC starts to provide a guaranteed or nearly guaranteed periodic income for life to the participant, subject to the claims paying ability of the insurance company. During the drawdown phase, the drawdown fund may provide a realistic drawdown schedule while nearly exhausting the funds by the time the participant attains the third predefined age. Upon the maturity of the QLAC (the maturity occurring when the participant attains the third predefined age), the periodic payments from the QLAC begin to flow to the participant, which may ensure an almost guaranteed income for life to the participant during the latter phases of retirement.

It should be understood that as used herein, the terms retirement account, retirement portfolio/plan, retirement income CIT, and retirement income plan/portfolio are used interchangeably. While described as for “a” participant, it is to be appreciated that the systems, methods, and apparatuses described herein are applicable with numerous participants.

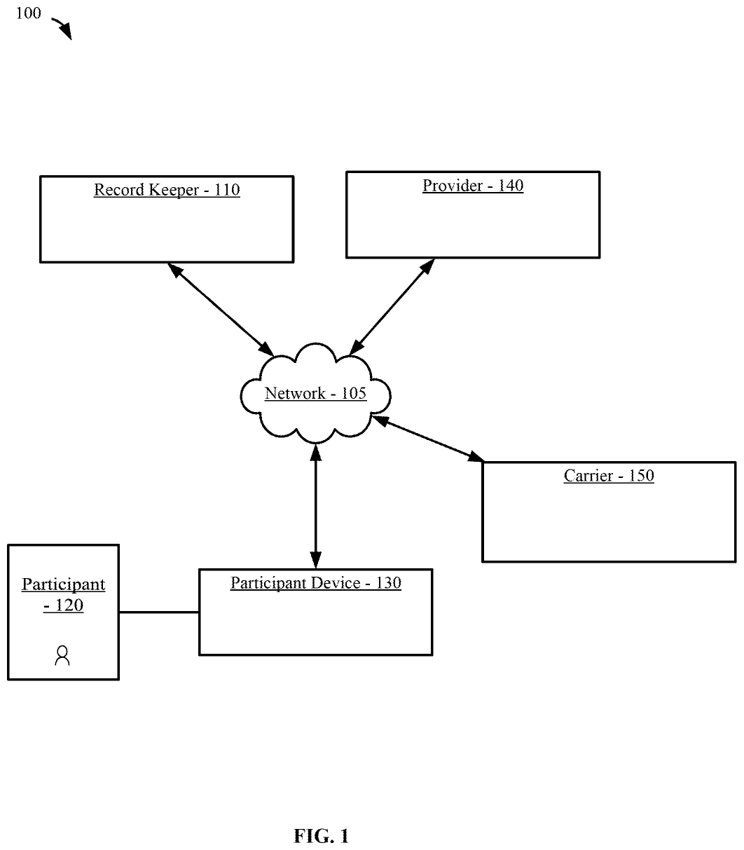

Referring now to FIG. 1, a block diagram of a system 100 for providing and implementing a retirement income CIT as an investment option in a plan sponsor's retirement plan is shown, according to an example embodiment. The system 100 includes a recordkeeper 110, a participant 120, a provider (also referred to as the asset manager) 140, and an insurance carrier 150. The recordkeeper 110, provider 140, and carrier 150 of the system 100 may manage a user's retirement account (i.e., the retirement income CIT) in a manner that not only helps the participant more optimally consume during retirement but also provides them with a guaranteed source of income, subject to the insurance company's ability to meet its claims, during the latter years in retirement.

The carrier 150 is an entity that may provide, manage, or otherwise hold an annuity product. In particular, the carrier 150 may provide, manage, or otherwise hold a single-life or a dual-life annuity product for a participant, which may be purchased with the funds in the QLAC prefunding strategy of the participant. In one embodiment and as described herein, the annuity product is a QLAC. The carrier 150 may be an insurance company, a financial institution, or any other entity capable of enabling the purchase and administration of a QLAC for a participant in the retirement income CIT.

The carrier 150 may cause, provide, or facilitate providing a periodic disbursal of funds to the user pursuant to the QLAC when the user reaches a predefined age (e.g., 85 years, referred to herein as the third predefined age). Thus, triggering of periodic income beneficially occurs a few years (namely, approximately twenty) after the user presumably retires, which may curb longevity risk and improve retirement spending on behalf of the user.

In some embodiments, the carrier 150 may hold or maintain a QLAC account for the participant separate from the retirement income CIT of the participant. Thus, the QLAC may be held or managed by the carrier 150 in an account separate from the retirement income CIT account held at the recordkeeper 110 for the participant 120. In other embodiments, the QLAC account may be held or managed by the recordkeeper 110 in addition to the retirement income CIT account.

The provider (also referred to as asset manager) 140 may be a sub-advisor for the recordkeeper 110 regarding administering a portion, or the whole, of the retirement income CIT for the participant. The provider 140 may be an asset management firm, a financial services corporation, a commercial or private bank, credit union, mobile wallet provider, or other financial institution.

In one embodiment, the provider 140 determines a policy framework defining the plurality of predefined events governing the various triggering events described above. For instance, the provider 140 may associate the occurrence of the plurality of predefined events with a specific age of the participant, and may provide the policy framework to the recordkeeper 110 for implementation. The recordkeeper 110 may carry out transactions according to the plurality of predefined events by following the recordkeeper's regular fund trading and/or pricing processes, and performing necessary trades via the National Securities Clearing Corporation (NSCC). Thus, the provider 140 plays an important role in defining the predefined events based on the age of a participant. In some embodiments as noted above, the actual actions associated with those predefined events may be performed by the recordkeeper 110. In alternate embodiments, however, one or more of these actions may be performed by the provider 140.

The provider 140 receives from the recordkeeper 110 a dataset containing information about participants who reach a second predefined age (e.g., 65 years, the presumptive age of retirement of a participant). This dataset may be received once per year (or another periodic time). The provider 140 provides the dataset to multiple carriers to request QLAC pricing quotes for the participants included in the dataset. The dataset may include: participant information (DOB, gender, marital status, zip code), participant job information (hourly/salaried/union status, job title, classification, description), if married then joint participant information (DOB, gender), QLAC purchase amount (estimate), and employer information. In some embodiments, the dataset may include other information as necessary for the multiple carriers to provide competitive QLAC pricing quotes to the provider.

Upon receiving the QLAC pricing quotes from multiple carriers, the provider 140 selects one of the carriers as the preselected or chosen carrier. In one embodiment, the preselection is based on pricing. In other embodiments, the preselection may be based not only on pricing, but on other criteria, such as business criteria including Insurance Carrier Financial Strength Committee (CF SC) ranking of carriers based on quantitative and qualitative criteria. The quantitative and qualitative criteria may comprise at least one of mandatory capital requirements and on-going supervision/rating to detect changes in an insurance carrier's stability and viability. Carriers which have a higher rating, or meet higher supervision standards may be preferred to other carriers, even though their pricing may be higher. Paying a higher premium for the QLAC may mitigate the risk that the chosen carrier will be unable to satisfy its obligations to the participant for the QLAC starting in 20 years' time.

The provider 140 informs the recordkeeper 110 about the preselected carrier. In turn, the recordkeeper 110 purchases subsequent batches of QLACs for the participants who have reached the second predefined age. It should be understood that the preselected carrier may change from one year to the next, and the provider keeps the recordkeeper informed about the currently preselected carrier if that preselected carrier changes.

The recordkeeper 110 may be an investment brokerage, a financial services corporation, a stockbroker, a bank, and so on. Accordingly, the recordkeeper 110 may facilitate, enable, or otherwise implement one or more transactions to manage the investments in the retirement income CIT.

In some embodiments, the recordkeeper 110 may engage the provider 140 for advice on the investments within the retirement income CIT as the plan participant increases in age (and, particularly, the TDF-based investment). Some of the advantages of the system may be a reduction in time for retirement planning for a participant by defaulting the participant into the retirement income CIT, and a reduction in the number of interactions between the system and the participant for maintaining the user's retirement portfolio based on whether the user accepts default choices made by the plan sponsor.

The recordkeeper 110 provides an option to the participant 120 (e.g., via the participant device 130) to invest in the retirement income CIT as one of several options for the participant to invest their retirement assets into. In some embodiments, the recordkeeper 110 causes new participants to invest all (i.e., 100%) of their retirement assets by default into the retirement income CIT. In other embodiments, a different amount of retirement assets are defaulted into the retirement income CIT.

The recordkeeper 110 may mark the opt-in status of each newly enrolled participant as “opted-in”. This means that each particular user's plan will include the QLAC purchase at the second predefined age using divested funds from the retirement income CIT. The recordkeeper 110 may provide an option for participants to opt-out of investing in the retirement income CIT at any time after enrollment. The recordkeeper 110 may provide an option for participants to opt-in to investing in the retirement income CIT at any time, for participants who had previously opted-out. For example and upon determining by the recordkeeper 110 that the user is currently listed as a participant in the retirement income CIT, a notification or prompt may be provided by the recordkeeper 110 to the participant device 130 inquiring the user to indicate whether he/she would like to remain opted-in in which case no response may be required or to opt-out of the retirement income CIT. In response and in some instances, the recordkeeper 110 may receive an opt-out indication from the user (e.g., via the participant device 130), which allows the user to opt-out of the retirement income CIT.

In some embodiments, the recordkeeper 110 allows the participant 120 to opt-in to specific transactions in the retirement income CIT and for plan sponsors to customize the retirement income CIT to their specific participant populations. The opt-in status of the participant may be “opted-in” by default.

The recordkeeper 110 omits participants that have an enrollment status of “enrolled” but have an opt-in status of “opted-out” from being processed based on their age at the plurality of predefined events. Such participants remain invested in a near-dated TDF portfolio.

An example of operation of transferring funds from the TDF-based portfolio of the retirement income CIT into the drawdown fund is as follows. There may be multiple TDFs separated by 5 years (of course, a different difference may be used to separate TDFs, such as one-year, three-year, etc.) that are available as investment options (e.g., TDF 2035 fund, TDF 2040 fund, TDF 2045 fund, etc.). The fund selected for a particular participant may be based on the age of the participant. For example, a user who is likely to retire at or near 2035 is determined to be invested in the 2035 TDF. So, the TDF for particular participants will vary based on their anticipated retirement age of 65. After or contemporaneously, the recordkeeper 110 determines a list of all the participants who reach the second predefined age (e.g., 65 years) during 2035. For all the participants with an opt-in status of “opted-in”, the recordkeeper 110 performs a transaction to transfer the current balance of the participant's assets in the 2035 TDF fund at the second predefined age into the drawdown fund. This process is repeated for years 2036, 2037, 2038 and 2039. Accordingly, a list is formed of participants with an opt-in status of “opted-in” who reach the second predefined age during any of these years. In other words, the recordkeeper 110 performs a transaction for all such participants to transfer the current balance in the 2035 TDF fund into the drawdown fund.

For those participants who have an opt-in status of “opted-out”, the recordkeeper 110 skips performing the transaction to transfer the current balance of their TDF (e.g., 2035 TDF) into the drawdown fund for every year that their status remains “opted-out”, and keeps the participants invested in their particular TDF (e.g., 2035 TDF). However and for this example 2035 TDF, upon reaching the year 2040, the recordkeeper 110 performs differently according to various embodiments. In one embodiment and still using the example 2035 TDF, the recordkeeper 110 performs a transfer of the TDF funds from the 2035 series to the TDF funds for the 2040 series, i.e., the “opted-out” participants may remain invested in a near-dated (i.e., 2040 series) TDF, with the TDF 2035 series being liquidated. In particular, the next TDF series fund—i.e., 2035 to 2040 or 2050 to 2055 TDFs—is the “near-dated” TDF. In some other embodiments, the current balance in the TDF 2035 series for such participants may remain invested in the same fund (without the fund being liquidated). In this regard, the funds may either be invested in a “through” manner (i.e., the asset allocation mix in the TDF 2035 fund is structured to keep undergoing changes until a particular asset allocation is reached), or a “to” manner (in which the asset allocation mix is frozen).

As mentioned herein, the recordkeeper 110 performs one or more transactions when a plurality of predefined events are detected with respect to the participant 120 in the retirement income CIT. In one embodiment, the predefined events refer to an age of the participant 120. In another embodiment, the predefined event refers to a mixture of an occurrence (i.e., an indication of retirement of the user) and an age of the user. In some embodiments, the recordkeeper 110 may implement the plurality of predefined events without requiring intervention by the participant. In some embodiments, the recordkeeper 110 may proceed with the purchase or transaction automatically if the participant has opted-in to accept actions for the retirement income CIT associated with the plurality of predefined events of the participant 120.

An example of transactions performed by the recordkeeper 110 based on a plurality of predefined events of the participant is as follows. Before the participant 120 reaches the first predefined age (e.g., 60 years), the recordkeeper 110 invests the current balance of the retirement income CIT in a TDF (hence and now, a TDF-based portfolio). When the age of the participant 120 is greater than or equal to the first predefined age but less than a second predefined age, the recordkeeper 110 divests a predetermined amount from the current balance of the TDF to invest in a QLAC prefunding strategy. This predefined amount may be performed on a periodic basis until the second predefined age (e.g., yearly). In some embodiments, the predetermined amount is a predetermined percentage or amount of the current balance of the retirement income CIT on a yearly basis (e.g., 3% per year). In one embodiment and in addition to the TDF (and, generally, the retirement income CIT), the QLAC prefunding strategy is provided and managed by the recordkeeper 110. In other embodiments, the QLAC prefunding strategy may be provided and managed by a different actor (e.g., the asset manager). By funding the QLAC purchase with funds accumulated annually, the system hedges against a point-in-time risk of the purchase had the QLAC purchase been made with fifteen percent of the asset base at retirement. Thus, until the participant 120 reaches the second predefined age (which is the presumptive age of retirement of the participant), the funds in the retirement income CIT are split between the TDF-based portfolio and the QLAC prefunding strategy. When the participant 120 reaches the second predefined age, the recordkeeper 110 performs two different transactions: (i) investing the current balance of the TDF-based portfolio into a drawdown fund, and (ii), using the current balance of the QLAC prefunding strategy to purchase a QLAC from a preselected carrier in accordance with IRS rules for the QLAC purchase. Thus, after the participant 120 reaches the second predefined age, the funds from the TDF-based portfolio of the retirement income CIT are entirely invested in the drawdown fund. The automatic performance of transactions at a plurality of predefined events based on the age of the participant 120 by the recordkeeper 110 is technically advantageous because it enables the computing systems involved to produce a more optimal allocation of participant resources than has historically been possible without the time-consuming process of obtaining user input.

As described herein, one of the predefined transactions may include the purchase of a QLAC after the occurrence of a predefined event (e.g., 65 years), which is presumptively the retirement age of the participant. The recordkeeper 110 receives information about a preselected carrier from the provider 140. The recordkeeper 110 purchases a subsequent batch of QLACs for all the participants who are eligible for the QLAC purchase from the preselected carrier. The recordkeeper 110 continues to use the preselected carrier for the purchase of QLACs in subsequent years, unless the recordkeeper 110 receives a different choice of the preselected carrier from the provider 140. In some embodiments, the purchased QLAC is provided, managed, and/or otherwise held by the preselected carrier, in which case, the recordkeeper 110 does not maintain information about the QLAC account (which is managed directly by the preselected carrier with the participant). In other embodiments, the QLAC may be provided, managed or held by the provider or the recordkeeper 110, along with the responsibility of management of the QLAC account by coordinating with the participant. The recordkeeper 110 provides a notification or alert to the participant 120 (e.g., via the participant device 130) when a transaction occurs (e.g., the purchase of a QLAC).

The provider 140 determines a drawdown schedule of retirement funds after the participant attains the second predefined age (e.g., 65 years). The provider 140 schedules the drawdown to begin at the second predefined age and to almost completely exhaust the funds in the drawdown fund by the third predefined age (e.g., 85 years) of the participant. The recordkeeper 110 causes, distributes, or facilitates a distribution of an amount received from liquidating a portion of the drawdown fund assets either by transferring the amount to an account designated by the participant 120 or by causing or facilitating a causing of a sending of a check for the amount to the participant (or, wire transfer, ACH transfer, etc.).

An example of a drawdown plan determined by the provider 140 is as follows. The provider 140 may determine a drawdown rate that results in a smooth income stream in retirement for the participant and nearly exhausts the balance in the drawdown fund by the time the participant attains the third predefined age. The periodic generation of income by an orderly liquidation of assets from the drawdown fund may provide a near optimal utilization of the retirement funds, and may lead to a more fruitful retirement for the participant (e.g., more events, more peace of mind, etc.). In one embodiment, the third predefined age may be 85 years, and the second predefined age may be 65 years. The recordkeeper 110 may liquidate a portion from the drawdown fund on a periodic basis and transfer the liquidated amount to a designated account of the participant at a financial institution of the participant's choice, or to send a check to the participant for the liquidated amount.

The provider 140 performs modeling regarding at least one of assessing the proportion of the at-retirement account balance to allocate to a QLAC, the QLAC distributions start date, rate risk hedging of the QLAC purchase, and/or an asset allocation with the QLAC. The modeling may be based on simulating lifecycle consumption across a large number of hypothetical plan participants. The simulations may incorporate a participant's income, income growth, taxes, savings rates, employer matching contributions, asset growth, IRS required minimum distributions, and retirement Social Security payments, along with other features. The optimal consumption strategy may be derived from a multi-period optimization of lifecycle consumption, which gives an optimal consumption amount each month based on current wealth, expected future income streams, a participant's risk aversion, and intertemporal consumption preferences. The model may be calibrated to mimic typical consumption patterns. Some examples of modeling considerations to be taken into account may be: consistency of income, general QLAC features, certainty of income relative to liquidity of the assets, start date of payments, access to early distribution, and inflation. It should be understood that the provider may employ any modeling scheme that produces probabilistic outcomes based on the complex interaction of multiple considerations (such as listed above). In one embodiment, the modeling may be performed with Monte Carlo simulations.

The recordkeeper 110 may notify participants that a portion of the current balance of their investment in the retirement income CIT will be distributed to fund a QLAC purchase from the preselected carrier, with the provision to send follow up communications to ensure that participants receive sufficient notice to opt out of the QLAC purchase, if desired by the participant. For example, a notification (push message, email, etc.) may be provided to the participant device 130.

It should be understood that the recordkeeper 110, provider 140, and carrier 150 may be different financial institutions, or they may be part of or owned by a single institution. That is, it is contemplated that all the roles attributed to the recordkeeper 110, provider 140, and carrier 150 may be implemented or performed by any one of them, or by a combination of the recordkeeper 110, the provider 140, and the carrier 150.

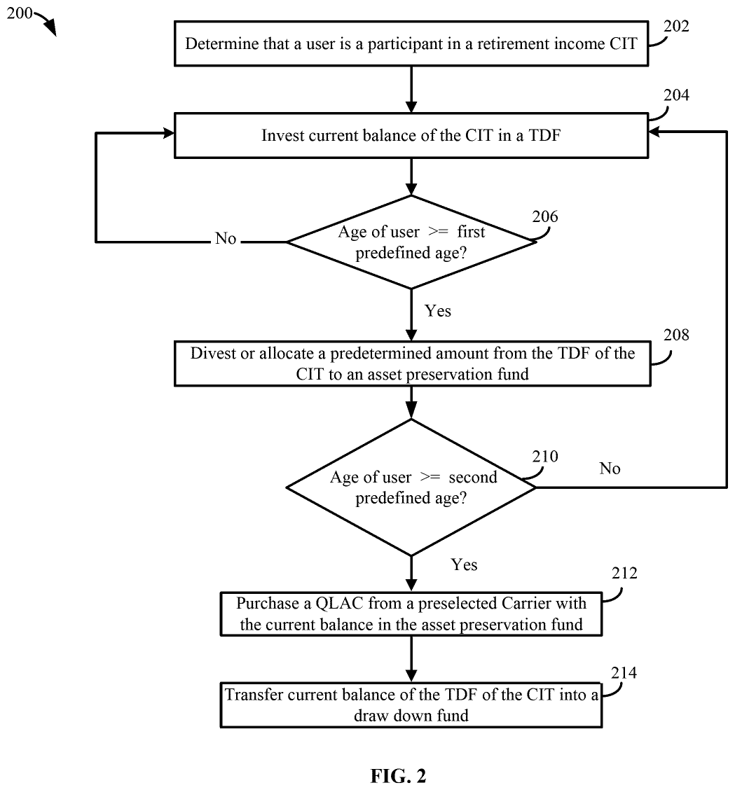

Referring now to FIG. 2, a method 200 for managing investments in a retirement income CIT as a function of a participant's age is shown, according to an example embodiment. Because the method 200 may be implemented with the system 100 of FIG. 1, references may be made to various components of the system 100 to aid explanation of the method 200.

At step 202, a determination that a user is a participant in a retirement income CIT is performed. The recordkeeper 110 may determine that the user is a participant in the retirement income CIT by checking or querying a list of retirement plan participants to identify the participants in the retirement income CIT. In one embodiment, this involves the recordkeeper 110 checking the enrollment status of the user to determine that the user has chosen to invest in the retirement income CIT, either by choice or by default. The determination also involves the recordkeeper 110 checking whether the user has opted-out of investing in the retirement income CIT.

At step 204, an investment of a current balance of the retirement income CIT is made in a TDF. Based on determining that the participant is in the retirement income CIT, the recordkeeper 110 causes (e.g., transfers, allocates, etc.) the participant's current funds balance in the retirement income CIT to be invested in a TDF and, particularly, the TDF that is closest to their likely retirement age (e.g., a 2040 TDF if the participant is expected to retire at or near 2040). The provider 140 determines an asset allocation for this investment in the TDF. The asset allocation is a mix of equity and fixed income investments. In one embodiment, the asset allocations are determined as a function of the age of the user (e.g., asset allocation at age 30, at age 35, etc.). The asset allocations may be determined for a variety of different age increments (e.g., 5 years, 1 year, 6 months, etc.). The asset allocations may be determined using one or more formulas, processes, and the like by the provider. The determination of asset allocation and subsequent investment in the TDF is common for all users enrolled in the retirement income CIT.

At 206, a comparison is performed regarding whether the user has attained a first predefined age. In particular, the recordkeeper 110 determines whether the current age of the user is greater than or equal to the first predefined age. If not, then the recordkeeper 110 maintains the current balance of the retirement income CIT for the user in the TDF just as in step 204. If yes, then the processing proceeds to step 208. In some embodiments, the first predefined age is 60 years. In another embodiments, a different age may be used. In operation, the recordkeeper 110 retrieves and continues to periodically retrieve (e.g., monthly, year, etc.) status information regarding the user (e.g., from the user, using a formula or algorithm based on the known user's age, etc.). This information may be stored and maintained in a database of the recordkeeper 110. The status information comprises an age of the user. Alternatively, the asset manager 140 may keep track of each participant's age and then provide a notification regarding the age to the recordkeeper 110 periodically (e.g., monthly, yearly, etc.).

At step 208, a predetermined amount is allocated or transferred from the current balance of the retirement income CIT into a separate QLAC prefunding strategy. This QLAC prefunding strategy may be an asset preservation fund intended to preserve the transferred or allocated assets of the participant for the subsequent QLAC purchase. The recordkeeper 110 performs the transferring of the predetermined amount from the TDF of the retirement income CIT into the QLAC prefunding strategy, which decreases the current balance of the TDF account of the retirement income CIT. This divestment process may continue on an annual basis or other periodic basis until the participant has reached the second predefined age. In particular, beginning at the first predefined age (e.g., 60), the annual amount allocated by the recordkeeper 110 from the CIT is three (3) percent of the current balance of the retirement income CIT toward long duration treasury STRIPS. Beneficially, this allocation mitigates a point-in-time risk of the QLAC purchase at the second predefined age.

At step 210, another comparison is performed regarding whether the user has attained a second predefined age. In particular, the recordkeeper 110 performs a comparison to determine whether the current age of the user is greater than or equal to the second predefined age. If not, then the recordkeeper 110 maintains the current balance of the retirement income CIT for the user continues in the TDF just as in step 204. If yes, then the processing proceeds to step 212. In some embodiments, the second predefined age is 65 years. In other embodiments, a different predefined second age is used. In this regard, the second predefined event is indicative of the user retiring. In one embodiment, the recordkeeper 110 determines when the user has reached the second predefined age. In some embodiments, detection of the second predefined event may be done via a variety of different ways. As an example, the plan sponsor may provide a notification regarding the user's retirement. As still another example, the user may provide an explicit input regarding their retirement.

At step 212, a QLAC purchase is made with a preselected carrier using a balance of the funds in the QLAC prefunding strategy. The recordkeeper 110 purchases the QLAC for the user, with the provider having provided advance notification to the recordkeeper 110 about the preselected carrier 150 from whom to purchase the QLAC for the user. Thus, in this embodiment, the provider 140 selects or chooses the carrier 150 from which the recordkeeper 110 will purchase the QLAC from. The QLAC purchase is performed for all users who have attained an age greater than the second predefined age. The recordkeeper 110 stops administering the QLAC beyond the initial purchase of the QLAC from the carrier 150. The carrier 150 initiates direct communication with the participant (e.g., via the participant device 130) to send a certificate and welcome kit to the participant and activate a web account (or some other alternate mechanism, such as exchanging information between the carrier and the participant about the new account to hold the QLAC for managing the QLAC account going forward). The carrier 150 assumes responsibility for enabling performance of the QLAC at a later date (e.g., when the user reaches the third predefined age, which presumptively coincides with the maturity of the QLAC). Thus, the carrier 150 may also receive status information regarding the user (e.g., date of birth or age information among other information regarding the participant) in order to track the age of the participant to determine when he/she reaches the third predefined age. In some embodiments, the third predefined age is 85 years. In other embodiments, the third predefined age may be different; but, greater than each of the first and second predefined ages.

At step 214, the current balance of the TDF of the retirement income CIT is transferred into a separate drawdown fund. Particularly, the recordkeeper 110 may transfer the current balance in the TDF of the retirement income CIT to the drawdown fund. The recordkeeper 110 may sell a portion of the assets from the drawdown fund on a periodic basis, and make the proceeds from the sale available to the participant.

Method 200, as described by the above steps, provides an automated computing system that produces enhanced sophistication and performance of retirement planning for participants. Despite the complexity of the transactions automatically performed during management of traditional TDFs, such traditional TDF solutions do not mitigate longevity risk on the part of plan participants. However, performing the sequence of steps described in method 200 produces a technical improvement to the computing systems involved in retirement planning over and above the technical benefits provided by traditional TDFs by addressing participant longevity risk autonomously. Performance of method 200 as described above not only eases the time-consuming process of obtaining user input for post-retirement planning where such input is necessary, but also limits the number of decision points where user intervention is needed at all, unlocking the ability to optimize the retirement portfolios of all participants in a post-retirement phase of life and, in doing so, improving the technical capacity of computing systems to more optimally manage retirement planning for participants.

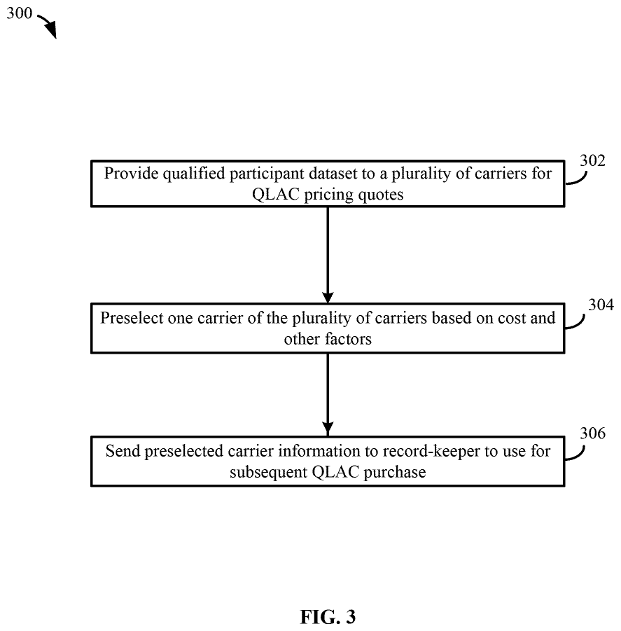

Referring now to FIG. 3, a method 300 for preselecting a carrier out of a plurality of carriers to be used for subsequent purchase of QLAC investments is shown, according to an example embodiment. Because the method 400 may be implemented by the system of FIG. 1, reference may be made to various components of FIG. 1 to aid explanation of the method 300.

At step 302, a qualified participant dataset is provided to a plurality of carriers for QLAC pricing quotes. In one embodiment, the provider 140 receives a dataset from the recordkeeper 110 containing information about the participants in the retirement income CIT who have attained at least the second predefined age (e.g., retired), and whose opt-in status indicates “opted-in” (thus, these participants are qualified in that they have chosen to opt-in to the retirement income CIT). For example, the provider 140 may provide the recordkeeper 110 a prompt for the dataset and subsequently receive the dataset. The qualified participant dataset is then shared by the provider 140 with a plurality of carriers 150 to obtain QLAC pricing quotes from the plurality of carriers for the qualified participants regarding the purchase of a QLAC from each of the plurality of carriers 150. The QLAC pricing quotes received by the provider 140 may be priced based on single/joint life, age 85 commencement, a return of premium options, cost of living adjustment, and an option to accelerate payments to an earlier age.

At step 304, a preselection is performed of one carrier out of the plurality of carriers. Particularly, the provider 140 may preselect one carrier out of the plurality of carriers based not only on cost of the QLAC quotes, but also other factors that may include Insurance Carrier Financial Strength Committee (CFSC) rank of the multiple carriers based on quantitative and qualitative criteria. The provider 140 evaluates solvency risk for a large portfolio (e.g., over 300) of insurance carriers, using a bottom up approach, reviewing each operating company independently. The provider 140 recognizes the interdependencies between the Holding Company and Operating Company but focuses much of the analysis around the Operating Company since that is where the claims paying obligation resides solely and exclusively. The provider 140 evaluates each Operating Company on a stand-alone basis and does not assume implicit financial support from the Holding Company. The preselection remains valid for the recordkeeper 110 to purchase QLAC for qualified participants until it is overridden the next time the preselection of one carrier is repeated with newer quotes being obtained from a plurality of carriers. In some embodiments, the preselection of a carrier for QLAC purchase may be performed once every year.

At step 306, the information about the preselected carrier is sent to the recordkeeper to use for subsequent QLAC purchases in annual batches for qualified participants who have attained the presumptive retirement age of the second predefined age. Thus, the provider 140 notifies the recordkeeper 110 of the preselection for the recordkeeper 110 to purchase the QLACs from the preselected carrier 150. In some embodiments, the second predefined age is 65 years, which is the presumptive age of retirement of participants in the retirement income CIT.

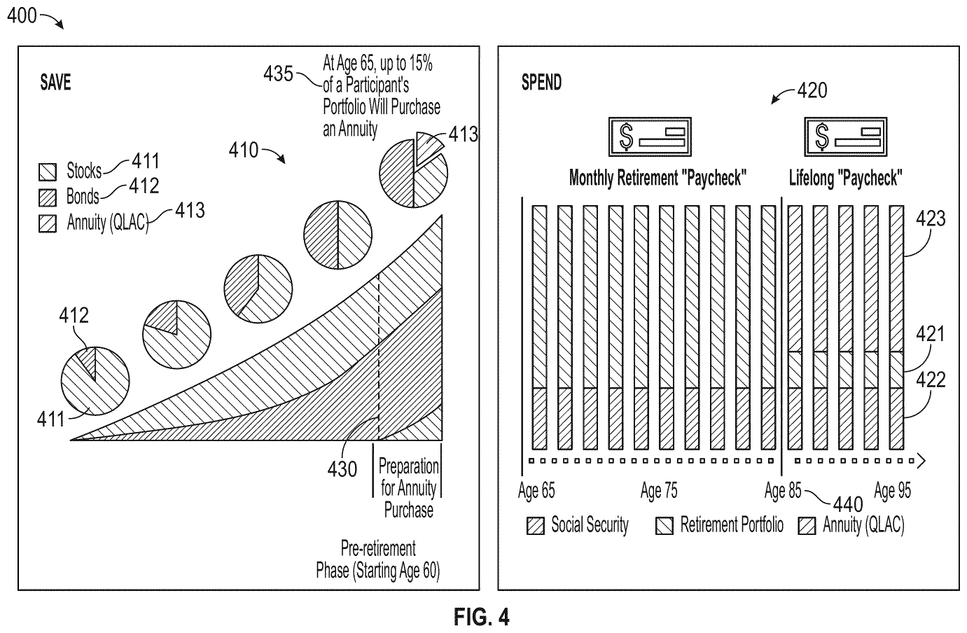

Referring now to FIG. 4, a graphical depiction 400 of changes in asset allocation and asset categories in a retirement income CIT as a function of an age of a participant is depicted, according to an example embodiment. The horizontal axis in FIG. 4 represents the age of the participant in the retirement income CIT, and is broken down into various phases comprising an accumulation phase 410 and a decumulation phase 420. The decumulation phase being triggered by an event—namely, retirement. In this example, the accumulation phase 410 lasts until the participant attains a first predefined age (in FIG. 4, the first predefined age is 60 years, which is earlier in time than the presumptive retirement age of 65 years). During the accumulation phase, the recordkeeper 110 may allocate a higher (or lesser, in some embodiments) percentage of the participant's current investment balance in the retirement income CIT (namely, the TDF) towards equity investments than towards fixed income investments than in a traditional TDF for a person with the same age as the participant. This may help maximize growth of the funds in the retirement income CIT during the accumulation phase of the participant's investment in the retirement income CIT. During phase 410, the recordkeeper 110 may recommend a smaller allocation to fixed income before the first predefined age, due to the availability of a QLAC as part of the retirement income CIT to provide a nearly guaranteed periodic income for life during the latter years of a participant's retirement. This seeks to provide a growth oriented accumulation phase 410 for the participant's investment in the retirement income CIT.

FIG. 4 also provides an example of how the asset allocation changes over time for a participant as the participant increases in age. Reference 411 depicts allocation to equity (that is, stock) investments, 412 depicts fixed income investments, and 413 depicts the allocation to purchase a QLAC using a portion of the user's retirement balance at a pre-determined time. Reference 421 depicts the orderly exhaustion of assets in the drawdown fund after the participant attains the second predefined age (i.e., the presumptive age of retirement), reference 422 depicts income from social security (an asset category), and reference 423 depicts the payments from a QLAC that has reached maturity upon the participant reaching the third predefined age.

In FIG. 4, during phase 420, the age of the participant is less than a second predefined age, although it is greater than or equal to the first predefined age 430. During phase 420, the recordkeeper 110 divests or allocates a predetermined amount or percentage of a current balance of the retirement income CIT and transfers the amount to a QLAC prefunding strategy. The prefunding strategy may include Treasury separate trading of registered interest and principal of securities (STRIPS), which are fixed income securities. Due to the divestment of a portion of the retirement income CIT into the QLAC prefunding strategy, the current balance in the retirement income CIT is decreased, while there is an increase in the assets invested in the fixed-income QLAC prefunding strategy. This is shown in phase 410 with icons that show the asset allocation as a function of age until the nexus with phase 420: at retirement when the QLAC purchase is made. Thus, an increase in the proportion of fixed income assets is provided in order to provide stabilization of the participant's pre-retirement balance from market fluctuations. In the example embodiment of FIG. 4, reference 435 indicates the time when the user attains the second predefined age, which is the presumptive age of retirement of the participant. At time 435, the recordkeeper 110 performs a couple of actions: first, the recordkeeper uses the balance in the QLAC prefunding strategy (up-to the maximum allowed by the IRS limit) to purchase a QLAC for the participant from a preselected carrier. Second, the recordkeeper 110 transfers the current balance in the retirement income CIT to a separate drawdown fund. Upon the purchase of the QLAC, the recordkeeper 110 relinquishes management responsibility for the QLAC with the preselected carrier being responsible for holding and managing the QLAC account for the participant directly with the participant. Consequently, there is no agreement between the plan sponsor (or the recordkeeper 110 on behalf of the plan sponsor) and the preselected carrier for QLAC distributions. In some embodiments, the second predefined age may be 65 years, although it could be different in some other embodiments to provide flexibility in the management of the retirement income CIT. The recordkeeper 110 may be structured to purchase the QLAC either with or without a cost-of- living-adjustment (COLA) feature. In one embodiment, a COLA feature is included and the COLA is three (3) percent. In some embodiments, the recordkeeper 110 may be structured to purchase a dual-life QLAC by default, which may include a return of premium guarantee, along with optional features for an early distribution option.

The portion of the portfolio used to purchase the QLAC becomes illiquid until the QLAC starts paying out a guaranteed periodic income, subject to the insurance company's claims paying ability, upon the participant reaching the third predefined age. Before the QLAC matures and starts generating nearly guaranteed income, the asset manager 140 provides a realistic drawdown schedule of retirement funds during the decumulation phase of retirement for the participant. While shown to age 95 of the participant, this phase lasts as long as the participant is alive. During the decumulation phase 420 which lasts from the second predefined age until the third predefined age of the participant, the recordkeeper 110 withdraws or facilitates withdrawal of retirement funds from the drawdown fund. During the decumulation phase 420, in an example embodiment, the provider 140 may use financial modeling to calculate a sustainable drawdown percentage on an annual basis, which may lead to the near exhaustion of the balance in the drawdown fund by the time that the participant attains the third predefined age, depicted as time 440 in the example of FIG. 4. The periodic generation of income by an orderly liquidation of assets from the drawdown fund may provide a near optimal utilization of retirement funds during the decumulation phase 420. This may lead to a more fruitful retirement for the participant (e.g., more events, more peace of mind, etc.). Referring back to the example embodiment of FIG. 4, the third predefined age may be 85 years, and the second predefined age may be 65 years. The recordkeeper 110 may liquidate a portion from the drawdown fund on a periodic basis and transfer the liquidated amount to a designated account of the participant at a financial institution of the participant's choice, or to send a check to the participant for the liquidated amount.

Referring still to FIG. 4, a portion of the participant's retirement income during phase 420 is presumed to come from social security 421. At time 440, the guaranteed periodic income for life starts due to the maturity of the earlier purchased QLAC. At this time, the participant can enjoy a mix of a guaranteed periodic income from the QLAC along with a combination of social security retirement income and income from remaining assets in the drawdown fund.

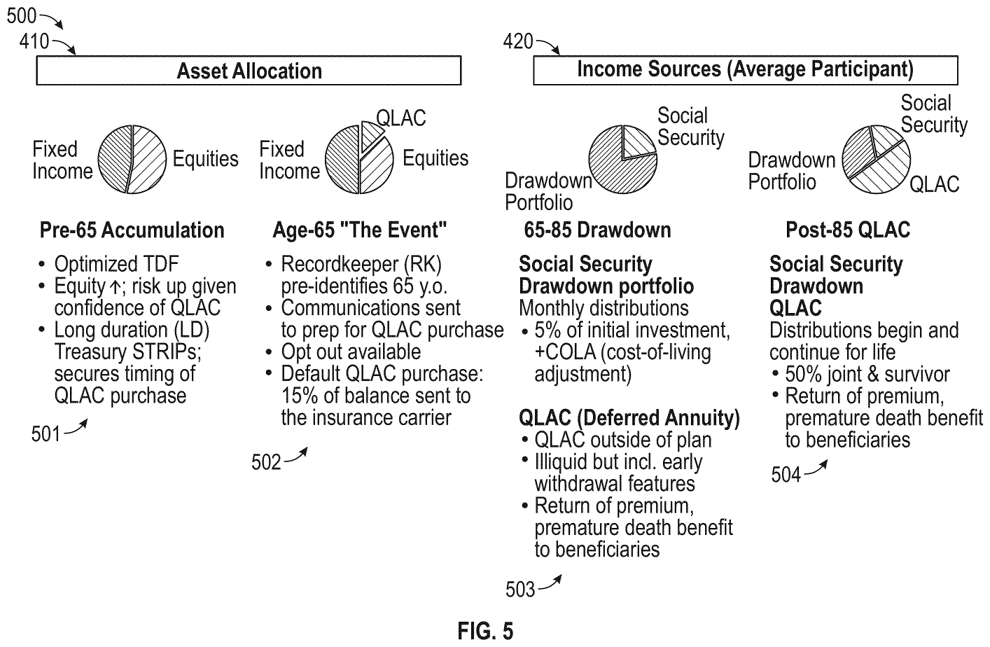

Referring now to FIG. 5, additional details regarding the accumulation 410 and decumulation 420 phases are shown, according to an example embodiment. Depiction 500 shows that pre-the second defined aged (i.e., the presumptive retirement age of 65), the accumulation phase 410 comprises an investment strategy that optimizes TDF with relatively higher equity investments which increases the risk but is acceptable due to the QLAC presence and fixed income investments comprising long duration treasury STRIPS that secure the timing of the QLAC purchase (501). At the “event” (502)—retirement at the second predefined age—the recordkeeper 110 pre-identifies all retirement age (e.g., 65) year olds in the particular TDF. The provider 140 preps for the QLAC purchase, participants are given an opportunity to opt-out of the QLAC purchase, and for those that do not opt-out, the QLAC purchase is made by sending the required funds to the insurance carrier. After the event and during the decumulation phase 420 and from the second predefined age (the presumptive retirement age of 65) to the third predefined age (the age at which the QLAC distributions begin, which is shown as age 85), the drawdown comprises social security and funds from the drawdown fund (monthly distributions of five percent the initial investment of the participant plus a COLA adjustment). The QLAC is outside the plan during this time and is illiquid; however, early withdrawal features are provided in that a return of premium and premature death benefit to beneficiaries are provided. This period is shown as reference number 503. At and after the third predefined age (in this example, 85), the participant may receive social security, funds from the drawdown fund, and the QLAC distributions begin. The QLAC distributions begin at the third predefined age and continue for life. Should the participant die, a return of the premium and premature death benefits are provided to the beneficiaries. This region is shown as reference number 504.

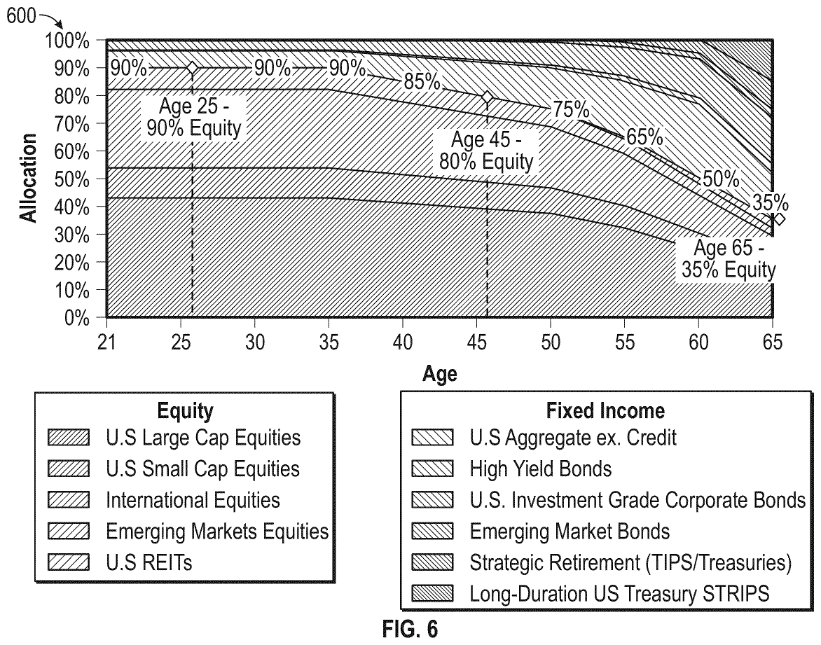

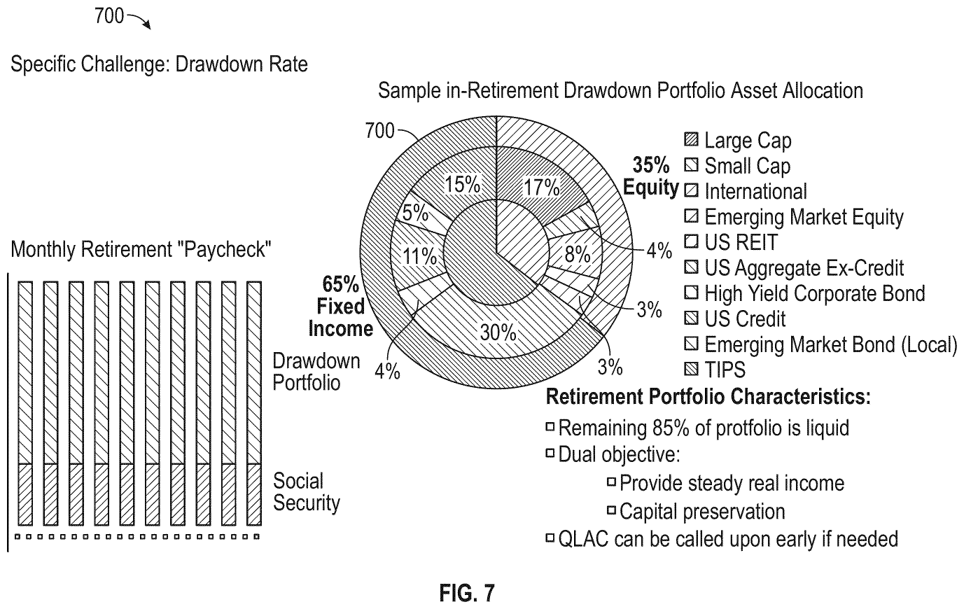

Referring now to FIGS. 6 and 7, detailed aspects of the asset allocation (FIG. 7) and retirement portfolio glide path (FIG. 6) for the participant in the retirement income CIT of the present disclosure are shown, according to example embodiments. In graph 600, the accumulation phase 410 is depicted with details regarding the specific allocations of equity and fixed income assets as a function of the participant's age. As shown, the equity allocation decreases from age 25 (90% equity) to age 45 (80% equity) to age 65 which is the presumptive retirement age (35% equity). The tables below the graph 600 depict the particular equity and fixed income allocations. In FIG. 7, a depiction 700 of the asset allocation of the drawdown funds after retirement and before the QLAC distributions is shown. This depiction 700 shows the asset allocation regarding where the participant's funds are coming from after retirement until the QLAC distributions begin. As shown in the upper graph 710, a relatively higher percentage (65%) of the drawdown portfolio is allocated to fixed income while a relatively smaller percentage (35%) is allocated towards equity investments. At this point, eighty-five percent of the participant's retirement portfolio is liquid (the remaining fifteen percent is in the illiquid QLAC investment). The objective is to provide steady real income after the third predefined age (85) and preserve one's capital. If needed, QLAC can be called upon before the third predefined age. Fines may result if triggered before the set distribution date (e.g., the third predefined age).

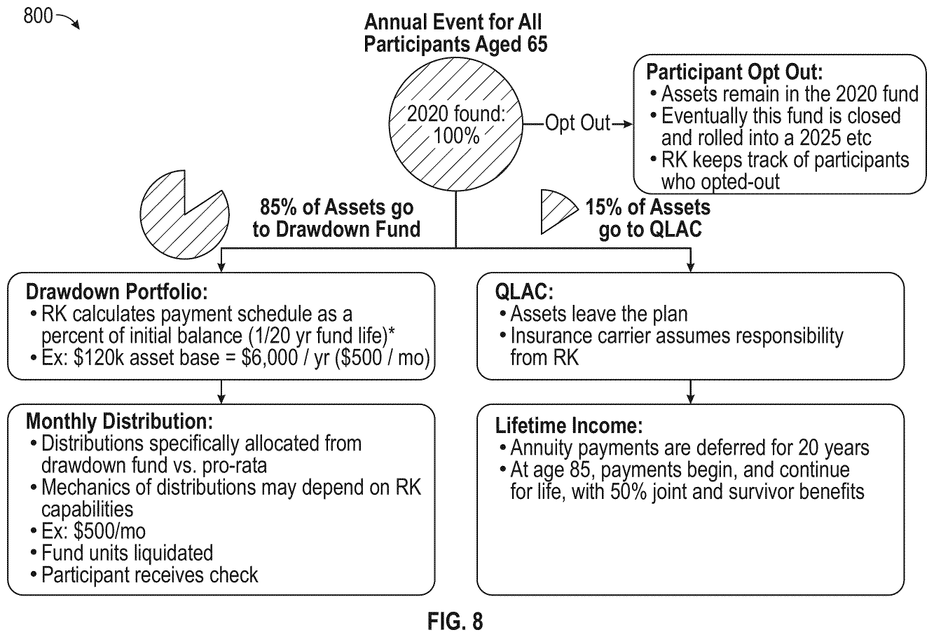

Referring now to FIG. 8, a graphical depiction 800 of a sample drawdown fund payment process is depicted, according to an example embodiment. In this example, the TDF is a 2020 TDF. In the year 2020, plan participants are given an option to opt-out of the QLAC purchase. If they opt-out, their assets remain in the TDF. The recordkeeper 110 keeps track of who opted-out. Eventually, the 2020 fund is rolled into the 2025 fund and so on. For the participants that did not opt-out, eighty-five percent of their assets are allocated into the drawdown fund while fifteen percent are used to fund the QLAC purchase. In other embodiments, different percentages may be utilized. The drawdown portfolio may have asset allocations as shown in FIGS. 4, 5, and 7. Before the third predefined age, the recordkeeper 110 determines or calculates a payment schedule for each participant as a function of their initial balance based on the years until the third predefined age (when the QLAC distributions begin). In this example, the number of years is twenty (from the presumptive retirement age of 65 to the third predefined age of 85). As an example, for a $120,000 asset base, the drawdown is equal to $6000/year ($500/month) based on the following formula: asset balance/years until QLAC distribution, which in this case is $120,000/20 years=$6000/year. Thus, a predefined amount of the drawdown fund per year is provided. The participant may then receive monthly distributions. A COLA may also be included in the predefined amount. Accordingly, a fixed or predefined amount of the drawdown fund may be liquidated with a COLA that is then provided by the recordkeeper 110 to the user. In one example, the participant receives a check. In another example, payment may be via other means (e.g., direct deposit into a chosen account, etc.). At the second predefined age (retirement), fifteen percent of the assets leave the plan to purchase the QLAC. At this point, the carrier 150 assumes responsibility for the QLAC from the recordkeeper 110. At the third predefined age, annuity payments from the QLAC purchase begin and continue for life with fifty percent joint and survivor benefits.

The arrangements described herein have been described with reference to drawings. The drawings illustrate certain details of specific arrangements that implement the systems, methods and programs described herein. However, describing the arrangements with drawings should not be construed as imposing on the system, apparatus, and methods described herein any limitations that may be present in the drawings.

It should be understood that no claim element herein is to be construed under the provisions of 35 U.S.C. § 112(f), unless the element is expressly recited using the phrase “means for.”

It should be understood that each of the recordkeeper 110, provider 140, and carrier 150 may own, manage, be a component of, or otherwise be associated with one or more computing systems. The computing system(s) may include one or more network interfaces that facilitate the exchange of information over the network 105, processing circuits having one or more processors and memory devices, databases, and other suitable computing components. The network interfaces may include Wi-Fi, Internet, a cellular modem, a Bluetooth transceiver, a Bluetooth beacon, a radio-frequency identification (RFID) transceiver, a near-field communication (NFC) transmitter, and/or any other type of networking chip that facilitates connection to the network 105 to communicate with the components and systems disclosed herein. The processors may be implemented as one or more application specific integrated circuits (ASICs), field programmable gate arrays (FPGAs), groups of processing components, or other suitable electronic processing components. The memory devices (or “memory”) may be one or more devices (e.g., RAM, ROM, Flash memory, hard disk storage) for storing data and/or computer code for completing and/or facilitating the various processes described herein. The memory may be or include non-transient volatile memory, non-volatile memory, and/or non-transitory computer storage media. The memory may store database components, object code components, script components, or any other type of information structure for supporting the various activities and information processing described herein. The memory may be coupled to the processor and include computer code or instructions for causing executing, by a computer system, of one or more processes described herein.

The participant device 130 is a computing device associated with the participant 120. The participant device 130 is structured to exchange data over the network 105, execute software applications, access websites, generate graphical user interfaces, and perform other operations described herein. The participant device 130 may include any sort of computing device, such as a smartphone, personal computer, a wearable computing device (e.g., eyewear, a watch or bracelet, etc.), a tablet, a portable gaming device, a laptop, and any other form of computing device (e.g., a smart appliance, a smart speaker, etc.). Thus, the participant device 130 may include a network interface, an input/output device, and a processing circuit. The network interface is structured to enable the exchange of communications between and among the participant device 130, provider (specifically, a computing system of the provider), and third party computing systems. Accordingly, the network interface may be or include a cellular modem, a Wi-Fi transceiver, a Bluetooth transceiver, a Bluetooth beacon, a RFID transceiver, a NFC transmitter, and/or any other network chip or arrangement for enabling communications and at least some of the functions described herein. The processing circuit is structured to control, at least partly, the participant device 130. The processing circuit includes memory and a processor. The processor may be implemented as a general-purpose processor, ASIC, one or more FPGAs, a DSP, a group of processing components, or other suitable electronic processing components. The one or more memory devices of memory (e.g., RAM, ROM, NVRAM, Flash Memory, hard disk storage, etc.) may store data and/or computer code for facilitating at least some of the various processes described herein. In this regard, the memory may store programming logic that, when executed by the processor, controls the operation of the user device 130. The input/output device may include a display that generates and provides a graphical user interface. Accordingly, the input/output device may include a touchscreen. In addition to touchscreen, input/output device 132 may also include a speaker, microphone, vibration motor, camera, other display devices, fingerprint sensors or scanners, and so on.

The various systems and devices may be communicatively and operatively coupled through the network 105, which may include one or more of the Internet, cellular network, Wi-Fi, Wi-Max, a proprietary banking network, any other type of wired or wireless network, or a combination of wired and wireless networks.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the system, apparatus, and methods described herein. Likewise, software and web implementations of the present disclosure could be accomplished with various programming techniques using rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this system, apparatus, and methods described herein. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

1. A non-transitory computer-readable medium storing instructions that, when executed by one or more processors, cause a computing system to:
determine that a user is a participant in a retirement income Collective Investment Trust (CIT);
in response to determining that the user is a participant in a retirement income CIT, periodically retrieve status information regarding the user comprising an age of the user and an enrollment status;
generate a financial model by using a Monte Carlo simulation to simulate financial consumption of the user, wherein the financial model is based on simulating lifecycle consumption across a plurality of hypothetical plan participants;
calibrate the financial model to mimic a typical consumption pattern;
determine an optimal consumption amount based on the financial model and a current wealth of the user, an expected future income stream of the user, a risk aversion of the user, and a consumption preference of the user;
determine a retirement income proportion of the user to invest in a qualified longevity annuity contract (QLAC) and a QLAC distribution start age of the user based on the optimal consumption amount;
in an instance in which the age of the user is less than a first predefined age, automatically and without input from the participant, invest a portion of the retirement income CIT in a Target-Date Fund (TDF);
in an instance in which the age of the user is greater than or equal to the first predefined age and less than a second predefined age, automatically and without input from the participant, periodically transfer a predetermined amount of funds from the TDF into an asset preservation fund based on the determined retirement income proportion of the user to invest in the QLAC; and
in an instance in which the age of the user is greater than or equal to the second predefined age:
receive a request for a qualified participant dataset from an asset manager computing system;
transmit the qualified participant dataset to the asset manager computing system, the qualified participant data set comprising information about participants who have reached the second predefined age;
receive information regarding a selected carrier from the asset manager computing system, wherein the selected carrier remains valid until overridden by a new selected carrier;
notify the user, via a user device, of an upcoming QLAC purchase from the selected carrier, the notification including an email message;
send a follow up communication to the user providing an option for the user to opt out of the QLAC purchase;
purchase a QLAC from the selected carrier with funds from the asset preservation fund;
transfer a current balance of the TDF into a draw down fund;
determine, on an annual basis, an annual draw down percentage of the draw down fund by determining an annual financial requirement of the user based on the user exhausting or nearly exhausting the draw down fund at a third predefined age, wherein the third predefined age is the same as the QLAC distribution start age of the user; and
distribute an amount received from liquidating a specific percentage of the draw down fund, wherein the specific percentage is substantially equal to the annual draw down percentage.

2. The non-transitory computer-readable medium of claim 1, wherein the instructions, when executed by the one or more processors, cause the computing system to transfer the predetermined amount of funds from the TDF into the asset preservation fund on a yearly basis until the second predefined age of the user.

3. The non-transitory computer-readable medium of claim 1, wherein the instructions, when executed by the one or more processors, cause the computing system to prompt the user to provide an input regarding the enrollment status of the retirement income CIT, and in response to the prompt, receive an opt-out indication from the user thereby removing the user from the retirement income CIT.

4. The non-transitory computer-readable medium of claim 1, wherein the instructions, when executed by the one or more processors, cause the computing system to allocate a relatively greater amount of assets in equity investments in the TDF than a standard target date fund before the user reaches the first predefined age.

5. The non-transitory computer-readable medium of claim 1, wherein the first predefined age is 60.

6. The non-transitory computer-readable medium of claim 1, wherein the second predefined age is 65.

7. The non-transitory computer-readable medium of claim 1, wherein the instructions, when executed by the one or more processors, cause the computing system to beginning at the first predefined age, allocate three (3) percent of the current balance of the retirement income CIT toward long duration treasury STRIPS annually to mitigate a point-in-time risk of the QLAC purchase at the second predefined age.

8. The non-transitory computer-readable medium of claim 1, wherein the QLAC purchased is one of a single life QLAC or a joint life QLAC, wherein the QLAC includes a cost of living expense (COLA), and wherein the COLA is approximately three percent.

9. The non-transitory computer-readable medium of claim 1, wherein the specific percentage includes a fixed percentage that is constant on the annual basis and a cost of living adjustment that is variable on the annual basis, and wherein the amount is either caused to be transferred to an account designated by the user or by sending a check for the amount to the user.

10. The non-transitory computer-readable medium of claim 1, wherein the instructions, when executed by the one or more processors, cause the computing system to in an instance in which the user reaches a third predefined age, cause periodic disbursal of funds to the user pursuant to the QLAC, and wherein the third predefined age is 85.

11. The non-transitory computer-readable medium of claim 1, wherein the instructions, when executed by the one or more processors, cause the computing system to in the instance in which the age of the user is greater than or equal to the first predefined age and less than a second predefined age, transfer a predetermined amount of funds from the TDF into the asset preservation fund which comprises Treasury STRIPS.

12. A recordkeeper computing system for managing and administering a retirement income plan, the system comprising:
a processing circuit comprising one or more processors coupled to non-transitory memory, the processing circuit structured to:
determine that a user is a participant in a retirement income Collective Investment Trust (CIT);
in response to the determination, periodically retrieve status information regarding the user comprising an age of the user and an enrollment status;
generate a financial model by using a Monte Carlo simulation to simulate financial consumption of the user, wherein the financial model is based on simulating lifecycle consumption across a plurality of hypothetical plan participants;
calibrate the financial model to mimic a typical consumption pattern;
determine an optimal consumption amount based on the financial model and a current wealth of the user, an expected future income stream of the user, a risk aversion of the user, and a consumption preference of the user;
determine a retirement income proportion of the user to invest in a qualified longevity annuity contract (QLAC) and a QLAC distribution start age of the user based on the optimal consumption amount;
responsive to determining that the age of the user is less than a first predefined age, automatically and without input from the participant, invest a portion of the retirement income CIT in a Target-Date Fund (TDF);
responsive to determining that the age of the user is greater than or equal to the first predefined age and less than a second predefined age, automatically and without input from the participant, periodically transfer a predetermined amount of the TDF into an asset preservation fund based on the determined retirement income proportion of the user to invest in the QLAC; and
responsive to determining that the age of the user is greater than or equal to the second predefined age,
receive a request for a qualified participant dataset from an asset manager computing system;
transmit the qualified participant dataset to the asset manager computing system, the qualified participant data set comprising information about participants who have reached the second predefined age;
receive information regarding a selected carrier from the asset manager computing system, wherein the selected carrier remains valid until overridden by a new selected carrier;
notify the user via a user device of an upcoming QLAC purchase from the selected carrier, the notification including an email message,
send a follow up communication to the user providing an option for the user to opt out of the QLAC purchase;
purchase a QLAC from the selected carrier with funds from the asset preservation fund;
transfer a current balance of the TDF into a draw down fund;
determine, on an annual basis, an annual draw down percentage of the draw down fund by determining an annual financial requirement of the user based on the user exhausting or nearly exhausting the draw down fund at a third predefined age, wherein the third predefined age is the same as the QLAC distribution start age of the user; and
distribute an amount received from liquidating a specific percentage of the draw down fund, wherein the specific percentage is substantially equal to the annual draw down percentage.

13. The system of claim 12, wherein the first predefined age is 60, the second predefined age is 65, and the predetermined amount is transferred annually to a Treasury STRIPS asset class within the retirement income CIT, wherein the predetermined amount that is transferred annually is three (3) percent of the current balance of the retirement income CIT.

14. The system of claim 12, wherein the QLAC purchased is one of a single life QLAC or a joint life QLAC.

15. A non-transitory computer-readable medium storing instructions that, when executed by one or more processors, cause a computing system to:
generate a financial model by using a Monte Carlo simulation to simulate financial consumption of a user, wherein the financial model is based on simulating lifecycle consumption across a plurality of hypothetical plan participants;
calibrate the financial model to mimic a typical consumption pattern;
determine an optimal consumption amount based on the financial model and a current wealth of the user, an expected future income stream of the user, a risk aversion of the user, and a consumption preference of the user;
determine a retirement income proportion of a participant to invest in a qualified longevity annuity contract (QLAC) and a QLAC distribution start age of the user based on the optimal consumption amount;
transmit a request for a qualified participant dataset to a recordkeeper computer system;
receive the qualified participant dataset from the recordkeeper computer system, the qualified participant dataset comprising participant information about participants who have reached a predefined age;
provide the qualified participant dataset with the participant information to multiple carriers for a qualified longevity annuity contract (QLAC) pricing quote, wherein the participant information includes the QLAC distribution start age of the participant and a QLAC purchase amount based on the retirement income proportion of the participant to invest in the QLAC;
upon receiving a response from the multiple carriers, select one carrier as the QLAC provider for a retirement income Collective Investment Trust (CIT) based on price and at least one other factor, wherein the at least one other factor comprises a solvency risk of each of the multiple carriers;
send information about the selected carrier to the recordkeeper computer system,. notify the user via a user device of an upcoming QLAC purchase from the selected carrier, the notification including an email message; and
send a follow up communication to the user providing an option for the user to opt out of the QLAC purchase.

16. (canceled)

17. The non-transitory computer-readable medium of claim 15, wherein the dataset comprises at least one of a participant date of birth, a participant marital status, participant job information, participant spouse information, and employer information regarding a participant.

18. The non-transitory computer-readable medium of claim 15, wherein the at least one other factor includes a Carrier Financial Strength Committee rank of the multiple carriers based on quantitative and qualitative criteria, wherein the quantitative and qualitative criteria comprise at least one of mandatory capital requirements and on-going supervision.

19. An asset manager computing system for providing a component for a retirement income plan, the system comprising:
a processing circuit comprising one or more processors coupled to non-transitory memory, the processing circuit structured to:
generate a financial model by using a Monte Carlo simulation to simulate financial consumption of a user, wherein the financial model is based on simulating lifecycle consumption across a plurality of hypothetical plan participants;
calibrate the financial model to mimic a typical consumption pattern;
determine an optimal consumption amount based on the financial model and a current wealth of the user, an expected future income stream of the user, a risk aversion of the user, and a consumption preference of the user;
determine a retirement income proportion of a participant to invest in a qualified longevity annuity contract (QLAC) and a QLAC distribution start age of the user based on the optimal consumption amount;
transmit a request for a qualified participant dataset to a record keeper computer system;
receive the qualified participant dataset from the record keeper computer system, the qualified participant dataset comprising participant information about participants who have reached a predefined age;
provide the qualified participant dataset with the participant information to multiple carriers for QLAC pricing quotes, wherein the participant information includes the QLAC distribution start age of the participant and a QLAC purchase amount based on the retirement income proportion of the participant to invest in the QLAC;
upon receiving a response from the multiple carriers, preselect one carrier as the QLAC provider for a retirement income Collective Investment Trust (CIT) based on price and at least one other factor, wherein the at least one other factor comprises a solvency risk of each of the multiple carriers;
send information about the selected carrier to a recordkeeper computer system;
notify the user, via a user device, of an upcoming QLAC purchase from the selected carrier, the notification including an email message; and
send a follow up communication to the user providing an option for the user to opt out of the QLAC purchase.

20. The system of claim 19, wherein the dataset comprises at least one of a participant date of birth, a participant marital status, participant job information, participant spouse information, and employer information regarding a participant.
